(19) United States
(12) Patent Application Publication
(10) Pub. No.: US 2007/0035963 A1
(43) Pub. Date: Feb. 15, 2007

(54) LAMP MODULE AND PROJECTING APPARATUS USING THE SAME

(76) Inventors: Cheng Wang, Hsinchu (TW); Ting-Heng Hsieh, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/422,883

(22) Filed: Jun. 8, 2006

(30) Foreign Application Priority Data
Aug. 9, 2005 (TW) 094127008

(51) Int. Cl. G01D 11/28

(52) U.S. Cl. 362/560; 362/298; 362/300; 362/302; 362/247

(57) ABSTRACT

A light source module comprises a light source, an elliptical reflector and a secondary reflector. The light source is used for generating a beam. The elliptical reflector is used for reflecting and converging the beam, the elliptical reflector has a first focus and second focus, and the center of the light source is located on the first focus. The secondary reflector is used for reflecting the beam to the elliptical reflector. A distance between the first focus and the second focus is X, and a distance between the first focus and the center of the elliptical reflector is Y, and X, Y satisfy Y≧−0.0012*X²+0.3728*X−6.8512.

### BACKGROUND OF THE INVENTION

1. Field of the Invention

The present invention relates to a lamp module and a projecting apparatus using the same, and more particularly to a lamp module installed with an elliptical reflector and a projecting apparatus using the same.

2. Description of Related Art

FIG. 1 is a schematic view of a lamp module structure of a conventional projecting apparatus. Please refer to FIG. 1. A lamp module 100 comprises an arc lamp 110 and an elliptical reflector 120, in which the arc lamp 110 comprises a light bulb 112 and a reflection layer 113 is plated on the right half wall of the bulb 112. The elliptical reflector has a first focus f1 and a second focus f2. The center O of the arc lamp 110 is located on the first focus f1. The arc lamp 110 is used for generating a beam L1, in which the left half of the beam L1 is gathered to enter an integration rod 130 located on the second focus f2 directly by means of the reflection of the elliptical reflector 120. Furthermore, the right half of the beam Li is incident back to the elliptical reflector 120 after being reflected by the reflecting layer 113, and then is gathered to enter the integration rod 130 on the second focus 12 by means of the reflection of the elliptical reflector 120.

It is sensitive for the design of the conventional elliptical reflector to an arc gap of the arc lamp 110; it can be known from the analysis, when the arc gap is 1.3 mm the luminous efficiency of the light source module 100 is approximately 83% to the luminous efficiency of the light source module 100 when the arc gap is 1.0 mm. After a long time use of the light source module 100, not only the luminous efficiency of the light source module 110 decreases, but also the optical coupling efficiency of the arc lamp 110 will also be greatly decreased after the arc gap become larger. Because of these double decreases, even if the brightness of the arc lamp is still maintained above 50%, but the brightness of the projecting apparatus is greatly decreased below 50% of the brightness of the projecting apparatus at original situation, this shortens the use life of the projecting apparatus. When the size of a panel used for the projecting apparatus is smaller, the life of the projecting apparatus is greatly lowered down, and the system efficiency thereof is far less than the one when a big-sized panel is used. Besides, the design of the reflecting layer 113 on the bulb 112 greatly decreases the emission efficiency of the arc lamp 110. Therefore, a high temperature persistent material must be used for the reflecting layer 113 so that the production cost is enhanced.

### SUMMARY OF THE INVENTION

One object of the present invention is to provide a light source module and a projecting apparatus using the same, capable of decreasing the sensitivity of the luminous efficiency of the lamp module vs. the arc gap by adjusting a distance between a first focus and the center of an elliptical reflector and a distance between a second focus and the center of the elliptical reflector.

According to the object mentioned above, the present invention proposes a lamp module, comprising a light source, elliptical reflector and secondary reflector. The light source is used for generating a beam. The elliptical reflector is used for reflecting and gathering a beam; the elliptical reflector has a first focus and second focus, and the center of the light source is located on the first focus. The second reflector is used for reflecting the beam to the elliptical reflector. The distance between the first focus and the second focus is X, the distance between the first focus and the center of the elliptical reflector is Y, and X, Y satisfy Y≧−0.0012*X²+0.3728*X−6.8512.

According to the object mentioned above, the present invention proposes a projecting apparatus, comprising a first lamp module and an integration rod. The first lamp module comprises a first light source, a first elliptical reflector and a first secondary reflector. The first light source is used for generating a first beam. The first elliptical reflector is used for reflecting and converging the first beam; the first elliptical reflector has a first focus and a second focus and the center of the first light source is located on the first focus. The first secondary reflector is used for reflecting the first beam to the first elliptical reflector. The distance between the first focus and the second focus is X1, the distance between the first focus and the center of the elliptical reflector is Y1, and X1, Y1 satisfy Y1 ≧−0.0012*X1²+0.3728*X1−6.8512.

### BRIEF DESCRIPTION OF THE DRAWINGS

The present invention can be more fully understood by reference to the following description and accompanying drawings, in which:

FIG. 1 is a schematic view of a lamp module structure of a conventional projecting apparatus;

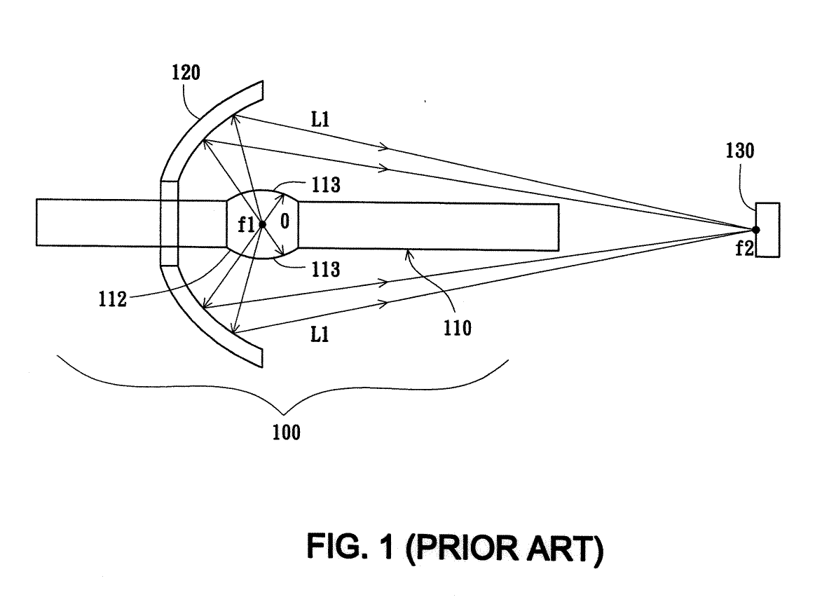

FIG. 2 is a schematic view, showing a lamp module structure of a projecting apparatus of a preferred embodiment according to the present invention;

FIG. 3 is a graph, showing an arc gap sensitivity curve and a secondary curve satisfying Y=−0.0012*X²+0.3728*X−6.8512 of a preferred embodiment according to the present invention;

FIG. 4 is a graph, showing a comparison between the arc gap and the luminous efficiency of the lamp module illustrated in FIG. 2 and the arc gap and the luminous efficiency of a traditional lamp module E22; and

FIG. 5 is is a schematic view, showing a projecting apparatus using two sets of lamp modules of another preferred embodiment according to the present invention

### DETAILED DESCRIPTION OF THE PREFERRED EMBODIMENTS

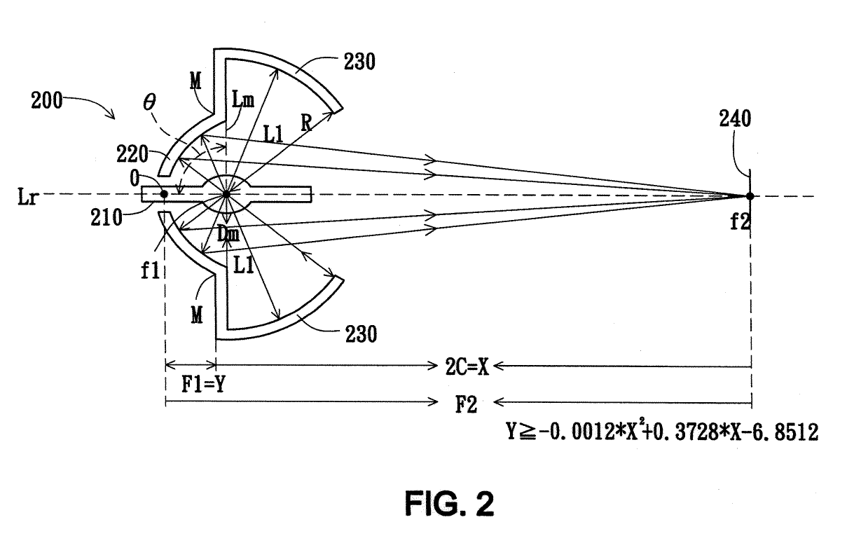

Please refer to FIG. 2. FIG. 2 shows a lamp module 200 structure of a projecting apparatus of a preferred embodiment according to the present invention. The lamp module 200 comprises a light source 210, an elliptical reflector 220 and a secondary reflector 230. The light source 210 such as an arc lamp is used for generating a beam L1. The elliptical reflector 220 is used for reflecting and converging the beam L1. The elliptical reflector 220 has a first focus f1 and a second focus f2. The center of the light source 210 is positioned on the first focus f1. The secondary reflector 230, such as a spherical reflector, is used for reflecting the beam L1 back onto the elliptical reflector 220. The beam L1 reflected by the elliptical reflector 220 is converged to enter an integration rod 240 positioned at the second focus f2.

As FIG. 2 shows, an included angle θ formed between a line Lm connected form the first focus f1 to the rim M of the elliptical reflector 220 and a line Lr connected from the first focus f1 to the center O of the elliptical reflector 220 is not smaller than 90 degrees so as to ensure part of the beam L1 returning on to the elliptical reflector 220 after being reflected by the secondary reflector 230. The center of the spherical surface of the secondary reflector is positioned at the center f1 (the first focus f1) of the light source 210. Besides, the curvature radius R of the secondary reflector 230 is larger than the distance Dm between the first focus f1 and the rim M of the elliptical reflector 220 so as to avoid stopping the beam L1 reflected from the elliptical reflector 220 not to be incident into the integration rod 240.

According to the embodiment, the present invention is characterized in that the sensitivity of luminous efficiency of the lamp module 200 vs. the arc gap is effectively decreased by adjusting the distance F1 between the first and the second focus f1 and the center O of the elliptical reflector 220 and the distance F2 between the first and the second focus f2 and the center O of the elliptical reflector 220. The distance between the first focus f1 and the second focus f2 is set to be 2C (=F2−F1). As Tables 1 to 6 showing, the secondary reflector 230 is a spherical reflector, and a constant value 2C is taken to measure under the conditions of different F1(F2) values, that the luminous efficiency ratios (%) to that the arc gap is 1.3 mm and that the arc gap is 1.0 mm of the lamp module 200, i.e. the optical coupling efficiency of the lamp module 200.

TABLE 1

| | | | Optical | arc |
|---|---|---|---|---|
| | | arc gap = 1.3 mm | Coupling | gap = 1.0 mm |
| | 2C = 54.19880 | luminous | efficiency | luminous |
| F1 | F2 | efficiency | (%) | efficiency |
| 17.35 | 71.54880 | 0.6173 | 101 | 0.6105 |
| 16.35 | 70.55 | 0.6018 | 100 | 0.5998 |
| 15.35 | 69.55 | 0.5875 | 100 | 0.5879 |
| 14.35 | 68.55 | 0.5672 | 99 | 0.5734 |
| 13.35 | 67.55 | 0.5471 | 99 | 0.5545 |
| 12.35 | 66.55 | 0.5215 | 97 | 0.5373 |
| 11.35 | 65.55 | 0.4925 | 96 | 0.5154 |
| 10.35 | 64.55 | 0.4541 | 93 | 0.4875 |
| 9.85 | 64.05 | 0.4301 | 89.72 | 0.4794 |
| 9.75 | 63.95 | 0.4250 | 89.485 | 0.4749 |
| 9.65 | 63.85 | 0.4212 | 89.4 | 0.4712 |
| 9.35 | 63.55 | 0.4066 | 89 | 0.4553 |
| 8.35 | 62.55 | 0.3559 | 86 | 0.4160 |
| 7.9006 | 62.09940 | 0.3265 | 83 | 0.3922 |

TABLE 2

| | | | Optical | |
|---|---|---|---|---|
| | | arc gap = 1.3 mm | Coupling | arc gap = 1.0 mm |
| | 2C = 56.15 | luminous | efficiency | luminous |
| F1 | F2 | efficiency | (%) | efficiency |
| 17.35 | 73.50 | 0.6338 | 99.09 | 0.6396 |
| 16.35 | 72.50 | 0.6176 | 98.93 | 0.6242 |
| 15.35 | 71.50 | 0.5987 | 97.95 | 0.6112 |
| 14.35 | 70.50 | 0.5782 | 97.40 | 0.5936 |
| 13.35 | 69.50 | 0.5544 | 96.43 | 0.5749 |
| 12.35 | 68.50 | 0.5256 | 95.13 | 0.5525 |
| 11.35 | 67.50 | 0.4966 | 94.34 | 0.5264 |
| 10.35 | 66.50 | 0.4576 | 91.80 | 0.4984 |
| 10.00 | 66.15 | 0.4295 | 89.79 | 0.4784 |
| 9.80 | 65.95 | 0.4206 | 89.11 | 0.4720 |
| 9.35 | 65.50 | 0.4110 | 88.98 | 0.4619 |

TABLE 3

| | | | Optical | |
|---|---|---|---|---|
| | | arc gap = 1.3 mm | Coupling | arc gap = 1.0 mm |
| | 2C = 61.15 | luminous | efficiency | luminous |
| F1 | F2 | efficiency | (%) | efficiency |
| 17.35 | 78.50 | 0.6177 | 99.34 | 0.6219 |
| 16.35 | 77.50 | 0.5995 | 98.05 | 0.6114 |
| 15.35 | 76.50 | 0.5820 | 97.20 | 0.5988 |
| 14.35 | 75.50 | 0.5580 | 95.48 | 0.5844 |
| 13.35 | 74.50 | 0.5345 | 94.08 | 0.5681 |
| 12.35 | 73.50 | 0.5070 | 92.59 | 0.5476 |
| 11.35 | 72.5000 | 0.4590 | 90.78 | 0.5056 |
| 10.35 | 71.50 | 0.4328 | 87.62 | 0.4940 |
| 9.35 | 70.50 | 0.3880 | 84.67 | 0.4582 |
| 8.35 | 69.50 | 0.3370 | 81.03 | 0.4158 |

TABLE 4

| | | | Optical | |
|---|---|---|---|---|
| | | arc gap = 1.3 mm | Coupling | arc gap = 1.0 mm |
| | 2C = 66.15 | luminous | efficiency | luminous |
| F1 | F2 | efficiency | (%) | efficiency |
| 18.35 | 84.50 | 0.6119 | 100.95 | 0.6061 |
| 17.35 | 83.50 | 0.5948 | 99.88 | 0.5955 |
| 16.35 | 82.50 | 0.5784 | 99.49 | 0.5813 |
| 15.35 | 81.50 | 0.5563 | 98.55 | 0.5645 |
| 14.35 | 80.50 | 0.5355 | 97.89 | 0.5471 |
| 13.35 | 79.50 | 0.5082 | 96.31 | 0.5277 |
| 12.35 | 78.50 | 0.4779 | 94.02 | 0.5083 |
| 11.85 | 78.00 | 0.4474 | 90.59 | 0.4939 |
| 11.35 | 77.50 | 0.4292 | 89.19 | 0.4812 |
| 11.15 | 77.30 | 0.4227 | 88.84 | 0.4758 |
| 10.95 | 77.10 | 0.4179 | 88.77 | 0.4708 |
| 10.35 | 76.50 | 0.4040 | 89.30 | 0.4523 |

TABLE 5

| | | | Optical | |
|---|---|---|---|---|
| | | arc gap = 1.3 mm | Coupling | arc gap = 1.0 mm |
| | 2C = 75.15 | luminous | efficiency | luminous |
| F1 | F2 | efficiency | (%) | efficiency |
| 17.35 | 92.50 | 0.5376 | 93.00 | 0.5781 |
| 16.35 | 91.50 | 0.5205 | 92.03 | 0.5656 |
| 15.35 | 90.50 | 0.5009 | 91.44 | 0.5477 |
| 14.85 | 90.00 | 0.4877 | 91.00 | 0.5359 |
| 14.35 | 89.50 | 0.4749 | 89.78 | 0.5289 |
| 13.35 | 88.50 | 0.4477 | 88.16 | 0.5079 |
| 12.35 | 87.50 | 0.4182 | 85.69 | 0.4881 |

TABLE 6

| | | | Optical | |
|---|---|---|---|---|
| | | arc gap = 1.3 mm | Coupling | arc gap = 1.0 mm |
| | 2C = 96.34911 | luminous | efficiency | luminous |
| F1 | F2 | efficiency | (%) | efficiency |
| 17.35 | 113.69911 | 0.4500 | 90.45 | 0.4975 |
| 16.35 | 112.69911 | 0.4277 | 89.09 | 0.4801 |
| 15.35 | 111.69911 | 0.4051 | 88.26 | 0.4589 |
| 14.35 | 110.69911 | 0.3794 | 87.40 | 0.4342 |
| 14.03 | 110.37870 | 0.3717 | 87.39 | 0.4253 |

As Table 1 shows, taking 2C=54.19880 to measure the optical coupling efficiency under the situation that F1 values are different, it can be known that the optical coupling efficiency is approximately 90% when F1 is 9.85 and the larger F1 is, the higher the optical coupling efficiency is. As Table 2 shows, taking 2C=56.15 to measure the optical coupling efficiency under the situation that F1 values are different, it can be known that the optical coupling efficiency is approximately 90% when F1 is 10 and the larger F1 is, the higher the optical coupling efficiency is. As Table 3 shows, taking 2C=61.15 to measure the optical coupling efficiency under the situation that F1 values are different, it can be known that the optical coupling efficiency is approximately 90% when F1 is 11.35 and the larger F1 is, the higher the optical coupling efficiency is. As Table 4 shows, taking 2C=66.15 to measure the optical coupling efficiency under the situation that F1 values are different, it can be known that the optical coupling efficiency is approximately 90% when F1 is 11.85 and the larger F1 is, the higher the optical coupling efficiency is. As Table 5 shows, taking 2C=75.15 to measure the optical coupling efficiency under the situation that F1 values are different, it can be known that the optical coupling efficiency is approximately 90% when F1 is 14.85 and the larger F1 is, the higher the optical coupling efficiency is. As Table 6 shows, taking 2C=96.34911 to measure the optical coupling efficiency under the situation that F1 values are different, it can be known that the optical coupling efficiency is approximately 90% when F1 is 17.35 and the larger F1 is, the higher the optical coupling efficiency is.

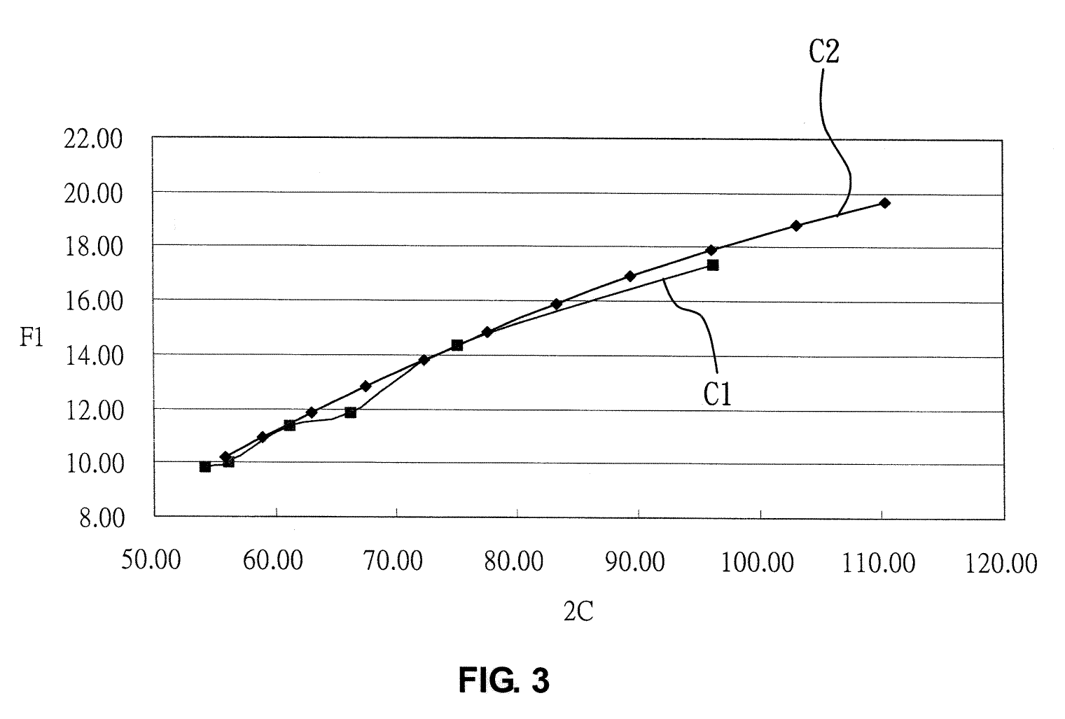

According to the analyses of six sets of data mentioned above, the corresponding relationship between the coefficients 2C and F1 under the situation that the optical coupling efficiency is approximately 90% as Table 7 shows and a corresponding arc gap sensitivity curve C1 as FIG. 3 shows can be sorted out.

TABLE 7

| 2C | F1 |
|---|---|
| 54.20 | 9.85 |
| 56.15 | 10.00 |
| 61.15 | 11.35 |
| 66.15 | 11.85 |
| 75.15 | 14.35 |
| 96.35 | 17.35 |

Next, take the optical coupling efficiency at least 90% and a curve of the second degree closest to the function of the curve C1 shown in FIG. 3, such as a curve of the second degree C2 satisfies Y=−0.0012*X²+0.3728*X−6.8512, in which X represents the distance 2C between the first and the second focuses f1 and f2, and Y represents the distance F1 between the first focus f1 and the center O of the elliptical reflector 220. Table 8 lists data, the coefficients 2C and F1, satisfies the function mentioned above.

TABLE 8

| 2C | F1 |
|---|---|
| 55.85 | 10.23 |
| 58.88 | 10.94 |
| 62.95 | 11.86 |
| 67.44 | 12.83 |
| 72.34 | 13.84 |
| 77.65 | 14.86 |
| 83.38 | 15.89 |
| 89.53 | 16.91 |
| 96.09 | 17.89 |
| 103.06 | 18.82 |
| 110.45 | 19.69 |

TABLE 9
F1 = 16.35, 2C = 61.15

| | | Luminous |
|---|---|---|
| | Luminous | efficiencies of |
| Arc gaps | efficiencies of the | traditional E22 |
| (mm) | present invention | lamp module |
| 1.00 | 100.00 | 100.00 |
| 1.10 | 99.42 | 96.40 |
| 1.20 | 98.71 | 92.83 |
| 1.30 | 98.47 | 89.06 |
| 1.40 | 96.32 | 85.99 |
| 1.50 | 94.50 | 82.74 |
| 1.60 | 92.58 | 78.67 |
| 1.70 | 90.27 | 76.12 |
| 1.80 | 88.75 | 72.90 |

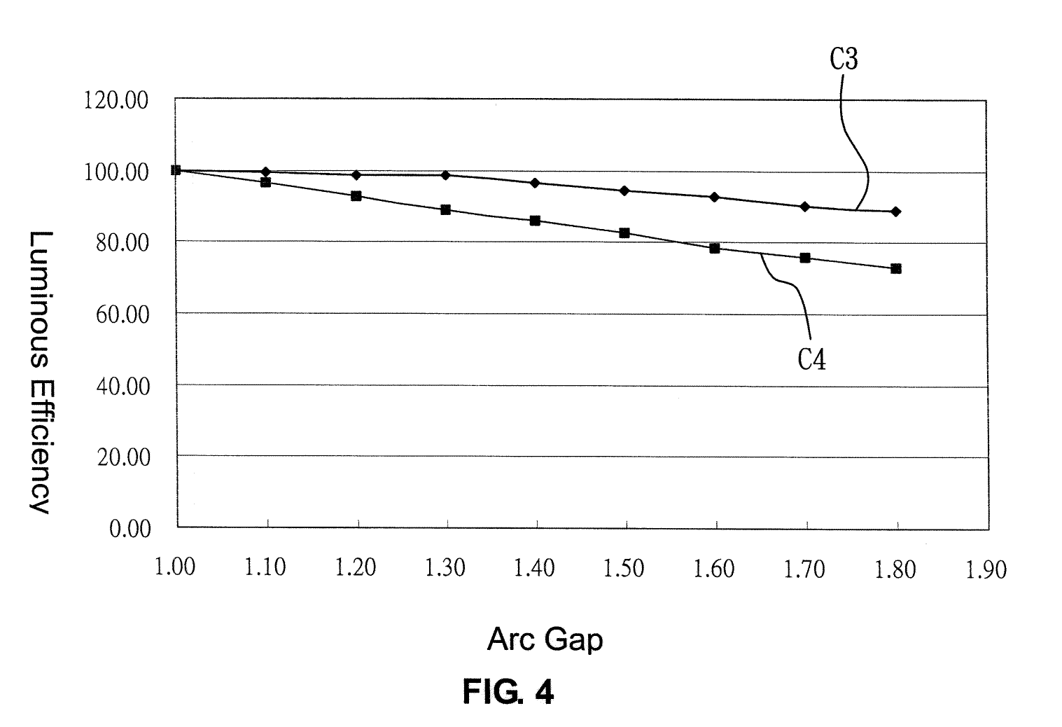

The curve C2, i.e. X and Y values satisfying Y≧−0.0012*X²+0.3728*X−6.8512, the optical coupling efficiencies to a same elliptical reflector 220 are at least larger than or equal to 90% when the arc gaps are respectively 1.3 mm and 1.0 mm. If a constant 2C value is taken, the larger a F1 value is, the more the optical coupling efficient is close to 100%, and even larger than 100%. Next, take a practical example to describe the detail. Table 9 is a table taking 2C=61.15 and F1=16.35 and showing a comparison relationship between the luminous efficiencies and the arc gaps of the lamp module 200 of the present invention and the luminous efficiencies and the arc gaps of a traditional E22 lamp module. Accordingly, curves C3 and C4 in FIG. 4 respectively represent the sensitivity of the luminous efficiency vs. the arc gap curves of the lamp module 200 of the present invention and the traditional E22 lamp module. It can be known from FIG. 4 that the lamp module 200 of the present invention allows the light source luminous efficiency to reach up to 94.5% when the arc gap is increased from 1.0 mm to 1.5 mm, but the luminous efficiency of the traditional E22 lamp module is only 82.74%. Even when the arc gap is further increased to 1.7 mm, the luminous efficiency of the lamp module 200 of the present invention is still beyond 90%, but the luminous efficiency of the traditional E22 lamp module is only 76% approximately. Therefore, the lamp module 200 of the present invention can increase the luminous efficiency at the optical coupling efficiencies of the arc gaps 1.3 mm and 1.0 mm up to beyond 90% at the conditions that the distance between the first focus f1 and the second focus f2 is X, the distance between the first focus f1 and the center O of the reflector is Y, and X and Y satisfy Y≧−0.0012*X²+0.3728*X−6.8512. This greatly decreases the sensitivity of luminous efficiency vs. the arc gap and increases the use life of the projecting apparatus.

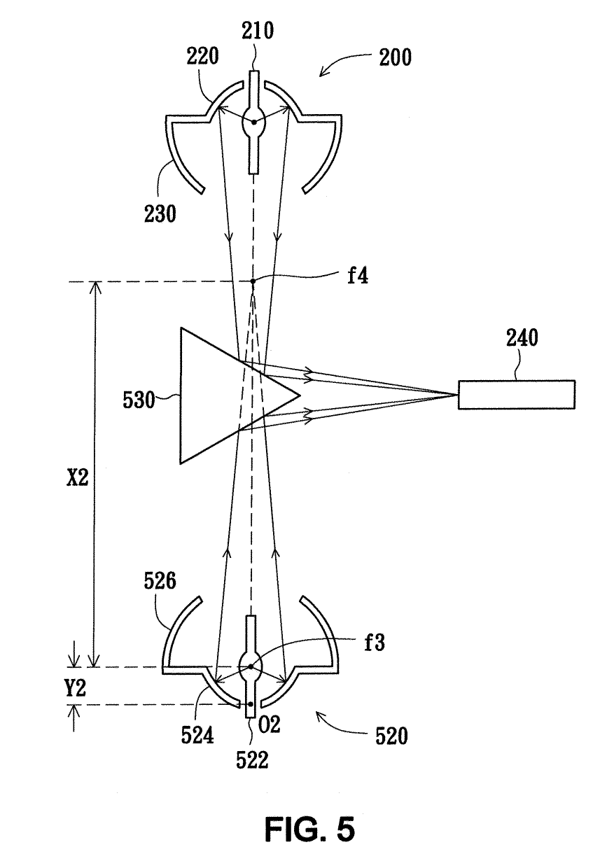

Besides, please refer to FIG. 5. FIG. 5 is a schematic view, showing a projecting apparatus structure with two sets of lamp modules of another preferred embodiment according to the present invention. The projecting apparatus of the present invention further comprises a second lamp module 520 and a reflection module 530. The second lamp module 520 comprises a second light source 522, a second elliptical reflector 524 and a secondary reflector 526. The structure of the second lamp module 520 is similar to the lamp module 200 mentioned above so that the detail thereof is omitted here. The distance between focuses f3 and f4 of the second lamp module 520 is X2, the distance between a focus f3 and the center of the elliptical reflector 524 is Y2, and X2 and Y2 also satisfy Y2≧−0.0012*X2ˆ2+0.3728*X2−6.8512. Besides, the reflection module 530, e.g. a prism, is used for reflecting the beam L1 reflected from the second elliptical reflector 524 and a beam reflected from the secondary reflector 526 to the integration rod 240. In addition, the reflection module 530 can also be a plane mirror module, a dichroic mirror module or a cold mirror module. However, they are not limited to these, a person skilled in the art could do an equivalent alternation.

Because the luminous efficiency vs. the arc gap sensitivity of the lamp modules 200 and 520 is obviously decreased, the luminous efficiency generated by two sets of lamp modules 200 and 520 used in the present invention is higher than the luminous efficiency generated by two sets of traditional lamp modules. Taking a lamp module with 330 W and the arc gap of 1.3 mm as an example, using a traditional projecting apparatus with a panel with 0.7 inch, the luminous brightness of single lamp module is approximately 3,000 lumens, and the luminous brightness of double lamps is only 1.5 times thereof, i.e. 4,500 lumens. But, if a projecting apparatus with the double lamp modules 200 and 520 of the present invention is used, the luminous brightness can reach up to above 6,000 lumens, it also means that the luminous brightness is increased to 2 times thereof.

As the description mentioned above, in FIG. 2 although the secondary reflector 230 is a spherical reflector in the present invention, it can also be an elliptical reflector. The central axis of the secondary reflector 230 is passed through the center O of the light source 210, and the distance R between any point on the secondary reflector 230 and the first focus f1 is larger than Dm. The beam L1 can be reflected back to the elliptical reflector 220 and is incident into the integration rod 240 without stopping to attain the object of increasing the luminous efficiency of the lamp module 200, it is within the scope of the present invention.

The present invention has the following merits:
1. The distances from the first and the second focuses of the elliptical reflector respectively to the center or the reflector is properly manipulated in the lamp module of the present invention, it allows the optical coupling efficiencies at the arc gaps 1.3 mm and 1.0 mm respectively to reach up to above 90% and the sensitivity of the luminous efficiency vs. the arc gap can be effectively decreased.
2. A lamp with a longer (e.g. longer than 1.3 mm) arc gap is used in the lamp module of the present invention; the life of a projecting apparatus can be extended at the same luminous power.
3. The longer an arc gap is, the higher the power of a lamp can be. At the present, to a lamp used for a projecting apparatus, 220 Watt is the upper limit for the lamp with an arc gap 1.0 mm and 330 Watt is the upper limit for the lamp with an arc gap 1.3 mm. Furthermore, the lamp module of the present invention causes no obvious difference between the arc gaps 10 and 1.3 mm so that the power and the luminous efficiency can be enhanced simultaneously.
4. Applying the lamp module of the present invention on a projecting apparatus with double lamps modules can increase luminous brightness over than two times of a single lamp module.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lamp module, comprising:
a light source, used for generating a beam;
an elliptical reflector, used for reflecting and converging said beam, said elliptical reflector having a first focus and a second focus, and a center of said light source being positioned on said first focus; and
a secondary reflector, used for reflecting said beam to said elliptical reflector;
wherein a distance between said first focus and said second focus is X, a distance between said first focus and the center of said elliptical reflector is Y, and X and Y satisfy Y≧−0.0012*X²+0.3728*X−6.8512.

2. The lamp module according to claim 1, wherein said light source is an arc lamp.

3. The lamp module according to claim 2, wherein an arc gap of said arc lamp is not smaller than 1.3 mm.

4. The lamp module according to claim 1, wherein an included angle formed by a connecting line from said first focus to the rim of said elliptical reflector and a connecting line from said first focus to the center of said elliptical reflector is not smaller than 90 degrees.

5. The lamp module according claim 1, wherein said secondary reflector is a spherical reflector, and a center of said spherical reflector is disposed on the center of said light source.

6. The lamp module according claim 1, wherein said secondary reflector is an elliptical reflector, and a central axis of said elliptical reflector is passed through the center of said light source.

7. The lamp module according to claim 1, wherein a distance between any point on said secondary reflector and said first focus is larger than a distance between from said first focus to the rim of said elliptical reflector.

8. The lamp module according to claim 1, being used in a projecting apparatus.

9. A projecting apparatus, comprising:
a first lamp module, comprising:
a first light source, used for generating a first beam;
a first elliptical reflector, used for reflecting and converging said first beam, said first elliptical reflector having a first focus and a second focus, and a center of said first light source being positioned on said first focus;
a first secondary reflector, used for reflecting said first beam to said first elliptical reflector; and
an integration rod, used for converging said first beam reflected from said first elliptical reflector;
wherein a distance between said first focus and said second focus is X1, a distance between said first focus and the center of said first elliptical reflector is Y1, and X1 and Y1 satisfy Y1≧−0.0012*X1²+0.3728*X1−6.8512.

10. The projecting apparatus according to claim 9, wherein said first light source is an arc lamp.

11. The projecting apparatus according to claim 10, wherein an arc gap of said arc lamp is not smaller than 1.3 mm.

12. The projecting apparatus according to claim 9, wherein an included angle formed by a connecting line from said first focus to the rim of said first elliptical reflector and a connecting line from said first focus to the center of said first elliptical reflector is not smaller than 90 degree.

13. The projecting apparatus according claim 9, wherein said first secondary reflector is a spherical reflector, and a center of said spherical reflector is positioned on the center of said first light source.

14. The projecting apparatus according claim 9, wherein said first secondary reflector is an elliptical reflector, and a central axis of said first elliptical reflector is passed through the center of said light source.

15. The projecting apparatus according to claim 9, wherein a distance between any point on said first secondary reflector and said first focus is larger than a distance between from said first focus to the rim of said first elliptical reflector.

16. The projecting apparatus according to claim 9, further comprising a second lamp module, comprising:
a second light source, used for generating a second beam;
a second elliptical reflector, used for reflecting and converging said second beam, said second elliptical reflector having a third focus and a fourth focus, and a center of said second light source being positioned on said third focus;
a second secondary reflector, used for reflecting said second beam to said second elliptical reflector; and
wherein a distance between said third focus and said fourth focus is X2, a distance between said third focus and the center of said second elliptical reflector is Y2, and X2 and Y2 satisfy Y2≧−0.0012*X2²+0.3728*X2−6.8512.

17. The projecting apparatus according to 16, further comprising a reflector module, used for reflecting said first beam and said second beam reflected respectively from said first elliptical reflector and said second elliptical reflector to said integration rod.

18. The projecting apparatus according to claim 17, wherein said reflector module is a prism.

19. The projecting apparatus according to claim 17, wherein said reflector module is chosen from a reflector module in a group constituted by a plane mirror module, dichroic mirror module and cold mirror module.
